(19) United States
(12) Patent Application Publication
(10) Pub. No.: US 2018/0034568 A1
(43) Pub. Date: Feb. 1, 2018

(54) METHOD AND ASSOCIATED APPARATUS FOR PERFORMING CABLE DIAGNOSTICS IN A NETWORK SYSTEM

(71) Applicant: Faraday Technology Corp., Hsin-Chu City (TW)

(72) Inventor: Chun-Hung Kuo, Hsin-Chu City (TW)

(21) Appl. No.: 15/334,297

(22) Filed: Oct. 26, 2016

(30) Foreign Application Priority Data
Jul. 29, 2016 (TW) 105124023

(51) Int. Cl. H04B 17/15; H04B 17/10

(52) U.S. Cl. CPC H04B 17/15; H04B 17/103

(57) ABSTRACT

A method for performing cable diagnostics in a network system and an associated apparatus are provided, where the network system includes a cable. The method includes: utilizing a transmitter to transmit a zero-crossing signal to a target twisted pair in the cable, wherein the transmitter is positioned in an electronic device within the network system, one end of the cable is electrically connected to the electronic device, and the zero-crossing signal includes a zero-crossing waveform; utilizing a receiver to receive a reflection signal of the zero-crossing signal from the target twisted pair, wherein the receiver is positioned in the electronic device; and detecting at least one characteristic of the reflection signal to generate a determination result, in order to allow the electronic device to process according to the determination result.

### BACKGROUND OF THE INVENTION

### 1. Field of the Invention

The present invention relates to testing a cable, and more particularly, to a method and associated apparatus for performing cable diagnostics in a network system.

### 2. Description of the Prior Art

Special equipment is required for testing a cable (e.g. a cable having a lot of twisted pairs). A terminal user will usually not have the special equipment, and may not be willing to purchase the special equipment as they will need to pay a high price. Accordingly, when a system that adopts the cable malfunctions, it is difficult to tell whether the malfunction is caused by the cable or by other factors. Related art methods fail to properly solve this problem without introducing side effects.

Hence, there is a need for a novel method and associated scheme which can improve the convenience of testing a cable without introducing side effects.

### SUMMARY OF THE INVENTION

An objective of the present invention is to provide a method and associated apparatus for performing cable diagnostics in a network system, to solve the aforementioned problem.

Another objective of the present invention is to provide a method and associated apparatus for performing cable diagnostics in a network system, in order to raise the overall performance of the network system without introducing side effects.

At least one embodiment of the present invention provides a method for performing cable diagnostics in a network system, wherein the network system comprises a cable. The method comprises the following steps: utilizing a transmitter to transmit a zero-crossing signal to a target twisted pair in the cable, wherein the transmitter is positioned in an electronic device in the network system, one end of the cable is electrically connected to the electronic device, and the zero-crossing signal has a zero-crossing waveform; utilizing a receiver to receive a reflection signal of the zero-crossing signal from the target twisted pair, wherein the receiver is positioned in the electronic device; and detecting at least one characteristic of the reflection signal in order to generate at least one determination result to allow the electronic device process according to the determination result.

In addition to the above method, the present invention also provides an associated apparatus for performing cable diagnostics in a network system, wherein the network system comprises a cable. The apparatus comprises a transmitter and a receiver, and both the transmitter and receiver are positioned in an electronic device in the network system. The apparatus may further comprise a processing circuit, and the processing circuit is positioned in the electronic device and coupled to the transmitter and the receiver. The transmitter may be arranged to transmit a zero-crossing signal to a target twisted pair in the cable, wherein one end of the cable is electrically connected to the electronic device, and the zero-crossing signal has a zero-crossing waveform. Further, the receiver may be arranged to receive a reflection signal of the zero-crossing signal from the target twisted pair. In addition, the processing circuit maybe arranged to detect at least one characteristic of the reflection signal in order to generate at least one determination result, to allow the electronic device process according to the determination result.

The method and apparatus of the present invention may properly solve existing problems without introducing side effects, or in ways which are less likely to introduce side effects. Further, the method and apparatus of the present invention may automatically detect wrong wirings during hybrid diagnostics, and more particularly, may automatically fix the wrong wirings through switching paths. Hence, the method and apparatus of the present invention may effectively raise the overall efficiency of the network system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an apparatus for performing cable diagnostics in a network system according to an embodiment of the present invention.

FIG. 2 is a diagram illustrating a zero-crossing wave diagnostics scheme of a method for performing cable diagnostics in a network system according to an embodiment of the present invention.

FIG. 3 is a diagram illustrating the zero-crossing wave and a corresponding open/short-circuit determination result of the zero-crossing wave shown in FIG. 2 according to an embodiment of the present invention.

FIG. 4 is a diagram illustrating the correct/wrong wirings and a corresponding parameter determination result of the zero-crossing wave shown in FIG. 2 according to an embodiment of the present invention.

FIG. 5 is a diagram illustrating a portion of a work flow according to an embodiment of the present invention.

FIG. 6 is a diagram illustrating another portion of the work flow shown in FIG. 5.

FIG. 7 is a diagram illustrating various types of situations according to an embodiment of the present invention.

FIG. 8 is a diagram illustrating a portion of a work flow according to another embodiment of the present invention.

FIG. 9 is a diagram illustrating another portion of the work flow shown in FIG. 8.

FIG. 10 is a diagram illustrating implementation details of the detection signal comparing circuit shown in FIG. 1 according to an embodiment of the present invention.

### DETAILED DESCRIPTION

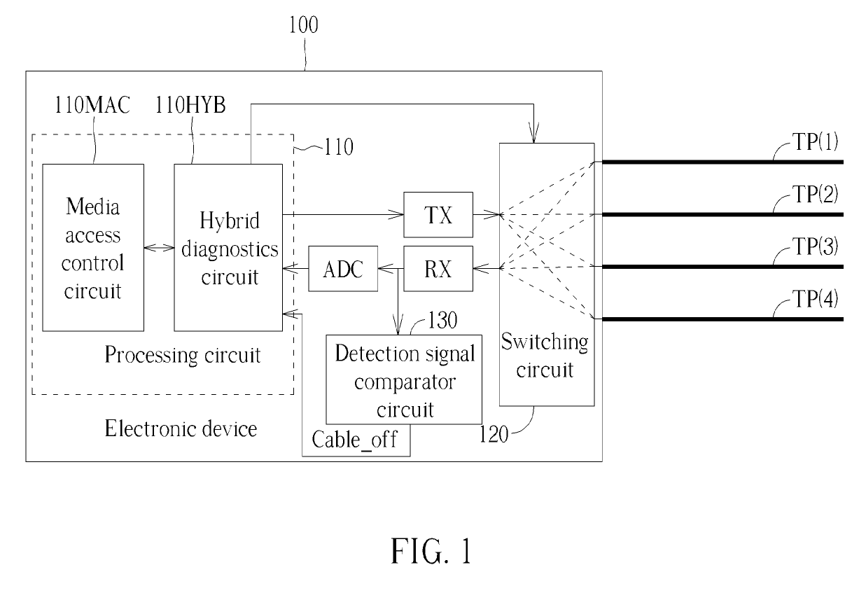

FIG. 1 is a diagram illustrating an apparatus for performing cable diagnostics in a network system according to an embodiment of the present invention. The network system may comprise an electronic device 100 and another electronic device (not shown). Examples of the electronic device 100 may comprise (but are not limited to): a personal computer (PC), router, network storage device and server. Examples of the other electronic device may comprise (but are not limited to): a PC, router, network storage device and server. Further, the network system may further comprise a cable having a plurality of twisted pairs. Examples of the cable may comprise (but are not limited to): a typical Category 5 (CAT-5) cable for connecting a PC to a local area network (LAN). In this embodiment, the twisted pairs may comprise the twisted pairs {TP (1), TP (2), TP (3), TP (4)}, and each of the twisted pairs {TP (1), TP (2), TP (3), TP (4)} may comprise two wires. For example, the cable may be connected between the electronic device 100 and the other electronic device.

The aforementioned apparatus (i.e. the apparatus for performing cable diagnostics in a network system) may comprise at least one portion (e.g. part or all) of the electronic device 100. For example, the apparatus may comprise a control circuit of the electronic device 100, such as a control circuit implemented by an integrated circuit (IC). In another example, the apparatus may comprise the whole electronic device 100, e.g. the apparatus may represent the whole electronic device 100. In another example, the apparatus may comprise a system of the electronic device 100, such as a computing system. As shown in FIG. 1, the electronic device 100 may comprise the processing circuit 110, switching circuit 120, transmitter TX, receiver RX, analog-to-digital converter ADC, and a detection signal comparator circuit 130. The processing circuit 110 may comprise the hybrid diagnostics circuit 110HYB and a media access control circuit 110MAC. The processing circuit 110 may be coupled to the transmitter TX, and may be coupled to the receiver RX through the analog-to-digital converter ADC. Further, the processing circuit 110 (especially the hybrid diagnostics circuit 110HYB therein) may directly control the conduction paths in the switching circuit 120. Through utilizing the switching circuit 120, the processing circuit 110 (especially the hybrid diagnostics circuit 110HYB therein) may couple the receiver RX to any of the twisted pairs {TP (1), TP (2), TP (3), TP (4)}, and may couple the transmitter TX to another of the twisted pairs {TP (1), TP (2), TP (3), TP (4)}. For example, under the control of the hybrid diagnostics circuit 110HYB, the transmitter TX may be coupled to one twisted pair within the twisted pairs {TP (1), TP (2), TP (3), TP (4)} through the switching circuit 120, and the receiver RX may be coupled to another twisted pair within the twisted pairs {TP (1), TP (2), TP (3), TP (4)} through the switching circuit 120.

In this embodiment, the apparatus may comprise the elements of the electronic device 100 shown in FIG. 1, such as the processing circuit 110, the switching circuit 120, the transmitter TX, the receiver RX, the analog-to-digital converter ADC, and the detection signal comparator circuit 130, wherein the control circuit may comprise at least one portion of the elements. For example, the processing circuit 110 may be implemented as the aforementioned IC, and may be an example of the control circuit. In another example, the hybrid diagnostics circuit 110HYB may be implemented as the aforementioned IC, and may be an example of the control circuit. In another example, the processing circuit 110, the switching circuit 120, the transmitter TX, the receiver RX, the analog-to-digital converter ADC, and the detection signal comparator circuit 130 may be integrated into a chip, and the chip may be an example of the control circuit, but this is merely for illustrative purposes, and is not a limitation of the present invention. According to some embodiments, the processing circuit 110 may be implemented as a customized circuit such as an application-specific integrated circuit (ASIC), and the hybrid diagnostics circuit 110HYB and MAC circuit 110MAC may be sub-circuits in the customized circuit. According to some embodiments, the processing circuit 110 may comprise at least one processor (e.g. one or more processors) and peripheral circuits of the aforementioned at least one processor. The processor may execute at least one program module, and the hybrid diagnostics circuit 110HYB may be implemented by executing one or more program modules of the processor.

In the embodiment of FIG. 1, the cable may be connected between the electronic device 100 and the other electronic device. Under a normal operation state (e.g. the cable does not malfunction), the MAC circuit 110MAC may perform MAC operations to transmit data to the receiver RX′ of the other electronic device by the transmitter TX, or receive data from the transmitter TX′ of the other electronic device by the receiver RX. Under an abnormal state, the electronic device 100 may be unable to receive data from the other electronic device. For better understanding, the state of the cable (normal or abnormal) in this embodiment is assumed to be unknown. The hybrid diagnostics circuit 110HYB may perform cable diagnostics to determine whether the cable malfunctions. For example, the hybrid diagnostics circuit 110HYB may determine whether any of the twisted pairs {TP (1), TP (2), TP (3), TP (4)} malfunctions, and then output a determination result for follow-up processing. In another example, the hybrid diagnostics circuit 110HYB may determine whether any two twisted pairs within the twisted pairs {TP (1), TP (2), TP (3), TP (4)1 are crossed over, and then output a determination result for follow-up processing. In another example, when it is determined that two twisted pairs within the twisted pairs {TP (1), TP (2), TP (3), TP (4)} are crossed over, the hybrid diagnostics circuit 110HYB will perform the follow-up processing, and more particularly, utilize the switching circuit 120 to directly fix the crossover problem.

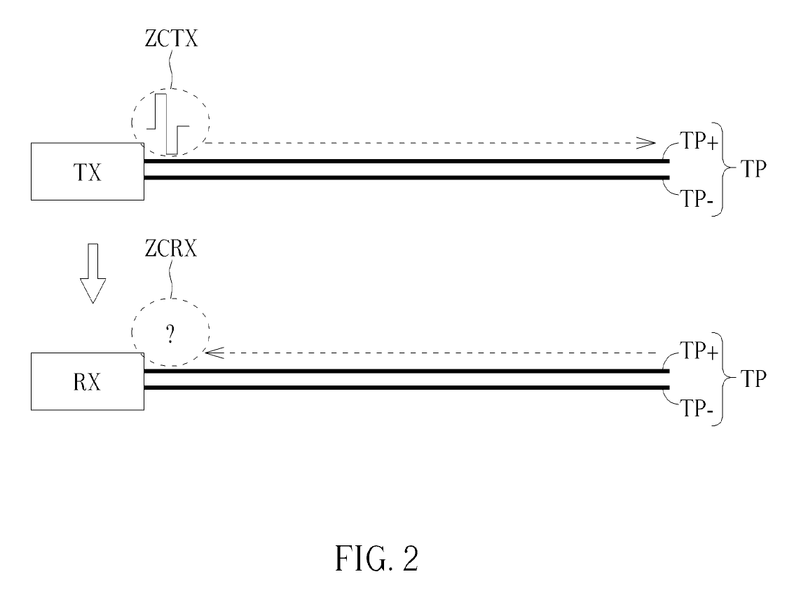

FIG. 2 is a diagram illustrating a zero-crossing wave diagnostics scheme of a method for performing cable diagnostics in a network system according to an embodiment of the present invention. The aforementioned method for performing cable diagnostics in a network system may be applied to the electronic device 100 shown in FIG. 1. More particularly, the method may be applied to the processing circuit 110 shown in FIG. 1, or the hybrid diagnostics circuit 110HYB shown in FIG. 1.

In this embodiment, the processing circuit 110 (e.g. the hybrid diagnostics circuit 110HYB) may select any of the twisted pairs {TP (1), TP (2), TP (3), TP (4)} in the cable as the target twisted pair TP. As shown in FIG. 2, the target twisted pair TP may comprise two wires TP+ and TP−. The processing circuit 110 (e.g. the hybrid diagnostics circuit 110HYB) may utilize the transmitter TX to transmit a zero-crossing signal ZCTZ to the target twisted pair TP, and may utilize the receiver RX to receive the reflection signal ZCRX of the zero-crossing signal ZCTX from the target twisted pair TP, wherein an end of the cable is electrically connected to the electronic device 100. Further, the processing circuit 110 (e.g. the hybrid diagnostics circuit 110HYB) may detect at least one characteristic of the reflection signal ZCRX (e.g. the symbol “?” in FIG. 2 shows that the reflection signal ZCRX is being detected), to generate at least one determination result, in order to allow the electronic device 100 to refer to the determination result to perform processing. In this embodiment, the zero-crossing signal ZCTX may have a zero-crossing waveform. Initially, the zero-crossing waveform of the zero-crossing signal ZCTX may be pulled up from a zero level (e.g. a common mode voltage), and then be pulled down and pass through the zero level and further pulled back to the zero level, as the waveform shown in the dotted circle in the upper half of FIG. 2. This is merely for illustrative purposes, and is not a limitation of the present invention. In some embodiments, the zero-crossing waveform of the zero-crossing signal ZCTX may be pulled down from the zero level (e.g. the common mode voltage), and then be pulled up and pass through the zero level, and be further pulled back to the zero level.

The detailed implementations of the upper half and lower half operations in FIG. 2 are illustrated as follows. The processing circuit 110 (e.g. the hybrid diagnostics circuit 110HYB) may utilize the switching circuit 120 to perform path switching, in order to allow the transmitter TX to transmit the zero-crossing signal ZCTX to the target twisted pair TP, and allow the receiver RX to immediately (instantly or quickly) receive the reflection signal ZCRX from the target twisted pair TP. Under the control of the processing circuit 110 (e.g. the hybrid diagnostics circuit 110HYB), the switching circuit 120 may have various hardware configurations. For each of the twisted pairs {TP (1), TP (2), TP (3), TP (4)}, such as the target twisted pair TP, the switching circuit 120 may have a first hardware configuration and a second hardware configuration, wherein the first hardware configuration and the second hardware configuration are respectively arranged to transmit and receive signals. For example, when the switching circuit 120 encounters the first hardware configuration of the target twisted pair TP, the switching circuit 120 may conduct the signal path between the transmitter TX and the target twisted pair TP in order to allow the transmitter TX to transmit the zero-crossing signal ZCTX to the target twisted pair TP through the switching circuit 120. In another example, when the switching circuit 120 encounters the second hardware configuration of the target twisted pair TP, the switching circuit 120 may conduct the signal path between the receiver RX and the target twisted pair TP in order to allow the receiver RX to receive the reflection signal ZCRX from the target twisted pair TP through the switching circuit 120. In this embodiment, the transmitter TX and the receiver RX may be jointly viewed as a transceiver, and the dotted lines in the switching circuit 120 of FIG. 1 indicate various signal paths between the transceiver and the twisted pairs {TP (1), TP (2), TP (3), TP (4)}.

Note that the reflection signal ZCRX may typically have a zero-crossing waveform, and the characteristic of the reflection signal ZCRX may comprise a zero-crossing direction of the zero-crossing waveform of the reflection signal ZCRX. The zero-crossing direction of the zero-crossing waveform of the reflection signal ZCRX may be changed according to the state of the target twisted pair TP. For example, the zero-crossing direction of the zero-crossing waveform of the reflection signal ZCRX may be the same as the zero-crossing direction of the zero-crossing waveform of the zero-crossing signal ZCTX. In another example, the zero-crossing direction of the zero-crossing waveform of the reflection signal ZCRX is opposite to the zero-crossing direction of the zero-crossing waveform of the zero-crossing signal ZCTX.

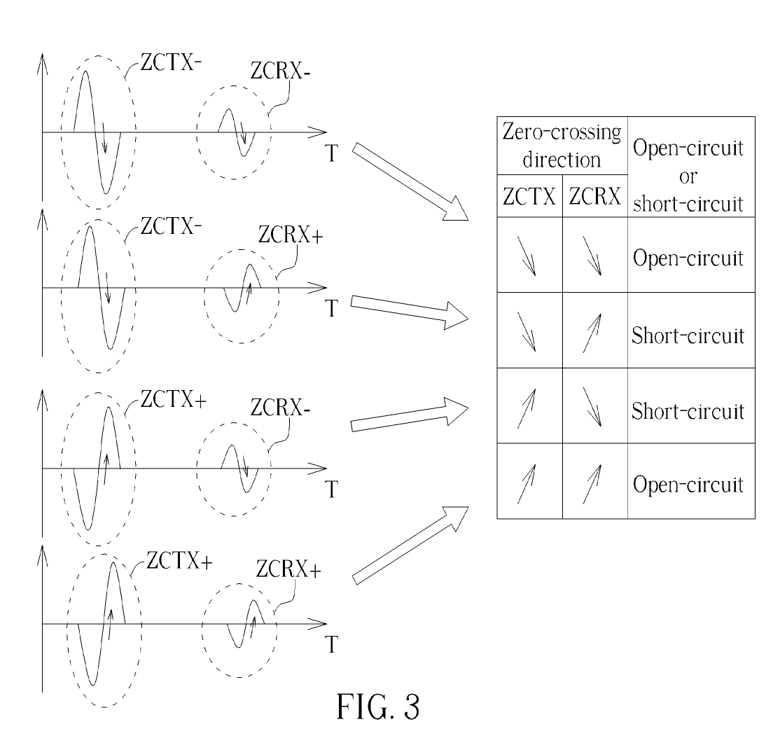

FIG. 3 is a diagram illustrating the zero-crossing wave and a corresponding open/short-circuit determination result of the zero-crossing wave shown in FIG. 2 according to an embodiment of the present invention, wherein the symbol “T” represents time. The zero-crossing signals ZCTX+ and ZCTX− may be examples of the zero-crossing signal ZCTX, and the reflection signals ZCRX+ and ZCRX− may be examples of the reflection signal ZCRX.

In this embodiment, when the zero-crossing direction of the zero-crossing waveform of the reflection signal ZCRX is the same as the zero-crossing direction of the zero-crossing waveform of the zero-crossing signal ZCTX, the aforementioned determination result may comprise an open-circuit determination result (e.g. the determination result denoted as “open-circuit” in FIG. 3), wherein the open-circuit determination result indicates that the two wires TP+ and TP− in the target twisted pair TP are open-circuit with respect to each other. For example, when the transmitter TX transmits the zero-crossing signal ZCTX− to the target twisted pair TP and the receiver RX receives the reflection signal ZCRX−, the processing circuit 110 (e.g. the hybrid diagnostics circuit 110HYB) may utilize the analog-to-digital converter ADC to sample the reflection signal ZCRX−, and detect that the zero-crossing direction of the zero-crossing waveform of the reflection signal ZCRX− is the same as the zero-crossing direction of the zero-crossing waveform of the zero-crossing signal ZCTX− (i.e. both downwards), and then determine that the two wires TP+ and TP− of the target twisted pair TP are open-circuit with respect to each other. In another example, when the transmitter TX transmits the zero-crossing signal ZCTX+ to the target twisted pair TP and the receiver RX receives the reflection signal ZCRX+, the processing circuit 110 (e.g. the hybrid diagnostics circuit 110HYB) may utilize the analog-to-digital converter ADC to sample the reflection signal ZCRX+, and detect that the zero-crossing direction of the zero-crossing waveform of the reflection signal ZCRX+ is the same as the zero-crossing direction of the zero-crossing waveform of the zero-crossing signal ZCTX+ (i.e. both upwards), and then determine that the two wires TP+ and TP− of the target twisted pair TP are open-circuit with respect to each other.

Further, when the zero-crossing direction of the zero-crossing waveform of the reflection signal ZCRX is opposite to the zero-crossing direction of the zero-crossing waveform of the zero-crossing signal ZCTX, the determination result comprises a short-circuit determination result (e.g. the determination result denoted as “short-circuit” in FIG. 3), wherein the short-circuit determination result indicates that the two wires TP+ and TP− of the target twisted pair TP are short-circuited. For example, when the transmitter TX transmits the zero-crossing signal ZCTX− to the target twisted pair TP and the receiver RX receives the reflection signal ZCRX+, the processing circuit 110 (e.g. the hybrid diagnostics circuit 110HYB) may utilize the analog-to-digital converter ADC to sample the reflection signal ZCRX+, and detect that the zero-crossing direction of the zero-crossing waveform of the reflection signal ZCRX+ (e.g. upwards) is opposite to the zero-crossing direction of the zero-crossing waveform of the zero-crossing signal ZCTX− (e.g. downwards), and then determine that the wires TP+ and TP− of the target twisted pair TP are short-circuited. In another example, when the transmitter TX transmits the zero-crossing signal ZCTX+ to the target twisted pair TP and the receiver RX receives the reflection signal ZCRX−, the processing circuit 110 (e.g. the hybrid diagnostics circuit 110HYB) may utilize the analog-to-digital converter ADC to sample the reflection signal ZCRX−, and detect that the zero-crossing direction of the zero-crossing waveform of the reflection signal ZCRX− (e.g. downwards) is opposite to the zero-crossing direction of the zero-crossing waveform of the zero-crossing signal ZCTX+ (e.g. upwards), and then determine that the wires TP+ and TP− of the target twisted pair TP are short-circuited.

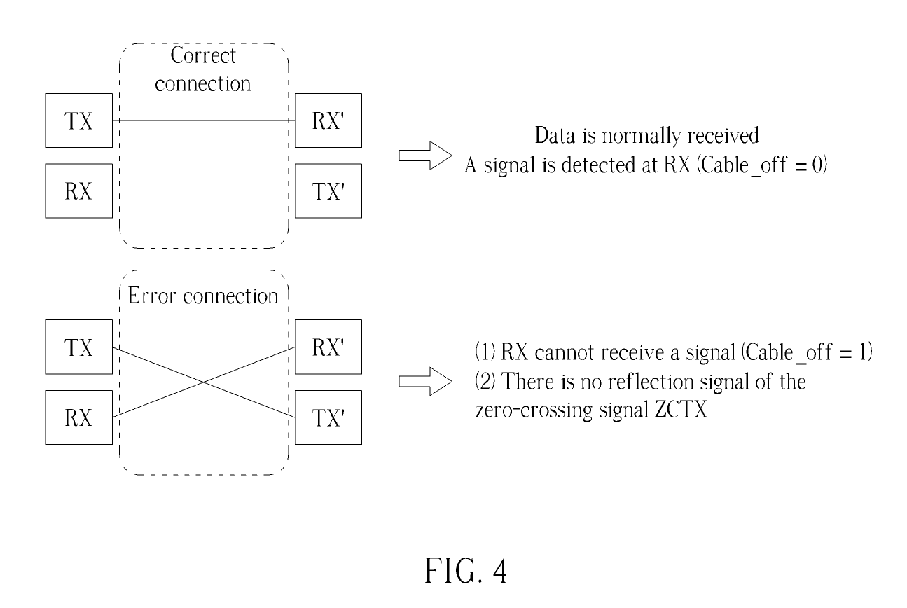

FIG. 4 is a diagram illustrating the correct/wrong wirings and a corresponding parameter determination result of the zero-crossing wave shown in FIG. 2 according to an embodiment of the present invention. In this embodiment, according to whether the logic value of the parameter Cable_off outputted by the detection signal comparator circuit 130 is 0or not, the hybrid diagnostics circuit 110HYB may determine whether there is a signal at the input end of the receiver RX.

When the transmitter TX of the electronic device 100 is electrically connected to the receiver RX′ of the other electronic device through one of the twisted pairs {TP (1), TP (2), TP (3), TP (4)}, and the receiver RX of the electronic device 100 is electrically connected to the transmitter TX′ of the other electronic device through another of the twisted pairs {TP (1), TP (2), TP (3), TP (4)}, the connections are viewed as correct connections. Hence, the transmitter TX may transmit data to the receiver RX′, and the receiver RX may receive data from the transmitter TX′. The electronic device 100 may normally transceive data under the correct connections. Further, when the logic value of the parameter Cable_off outputted by the detection signal comparator circuit 130 is 0, the hybrid diagnostics circuit 110HYB will determine that there is a signal at the input end of the receiver RX, and thereby determine that the cable is not disconnected.

In another example, when the transmitter TX of the electronic device 100 is electrically connected to the transmitter TX′ of the other electronic device through one of the twisted pairs {TP (1), TP (2), TP (3), TP (4)}, and the receiver RX of the electronic device 100 is electrically connected to the receiver RX′ of the other electronic device through another of the twisted pairs {TP (1), TP (2), TP (3), TP (4)}, the connections may be viewed as incorrect connections. In this situation, the transmitter TX cannot transmit data to the receiver RX′, and the receiver RX cannot receive data from the transmitter TX′ . The electronic device 100 cannot normally transceive data under incorrect connections. Further, when the logic value of the parameter Cable_off outputted by the detection signal comparator circuit 130 is 1, the hybrid diagnostics circuit 110HYB may determine that the receiver RX cannot receive any signal, which means that the cable may be loosened, disconnected, malfunctioning, etc. Further, based on the above zero-crossing wave diagnostics scheme, the hybrid diagnostics circuit 110HYB may control the transmitter TX to transmit the zero-crossing signal ZCTX. According to the sample value generated by the analog-to-digital converter ADC, however, the hybrid diagnostics circuit 110HYB may determine whether there is a corresponding reflection wave after the transmitter TX sends the zero-crossing signal ZCTX, such as the aforementioned reflection signal ZCRX. In this way, the hybrid diagnostics circuit 110HYB may determine that the cable is short-circuited or open-circuit.

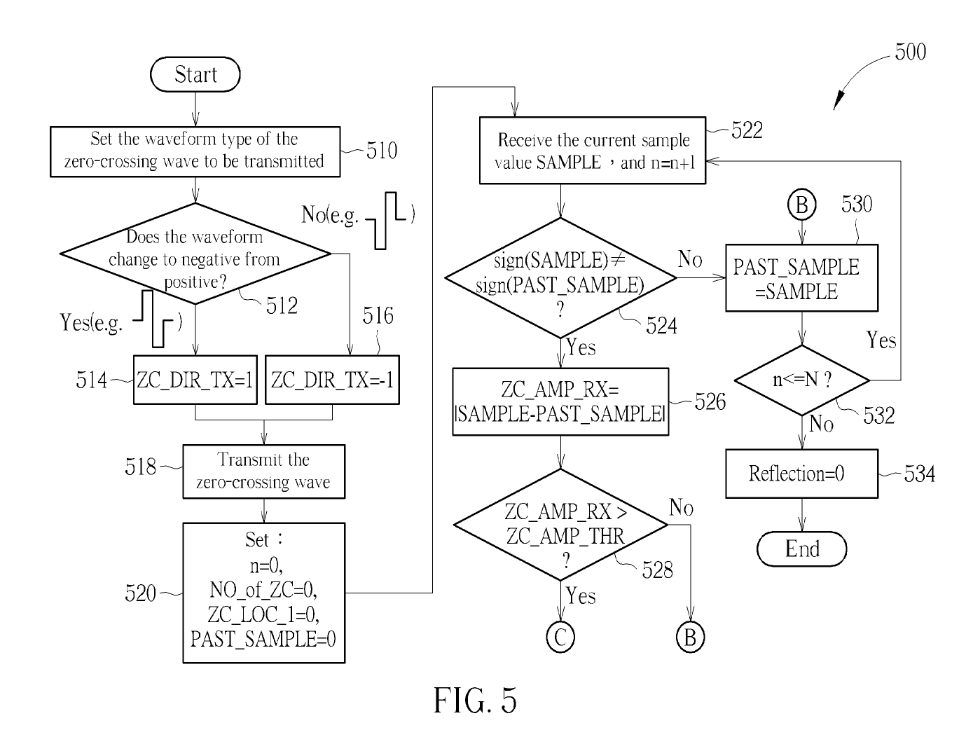

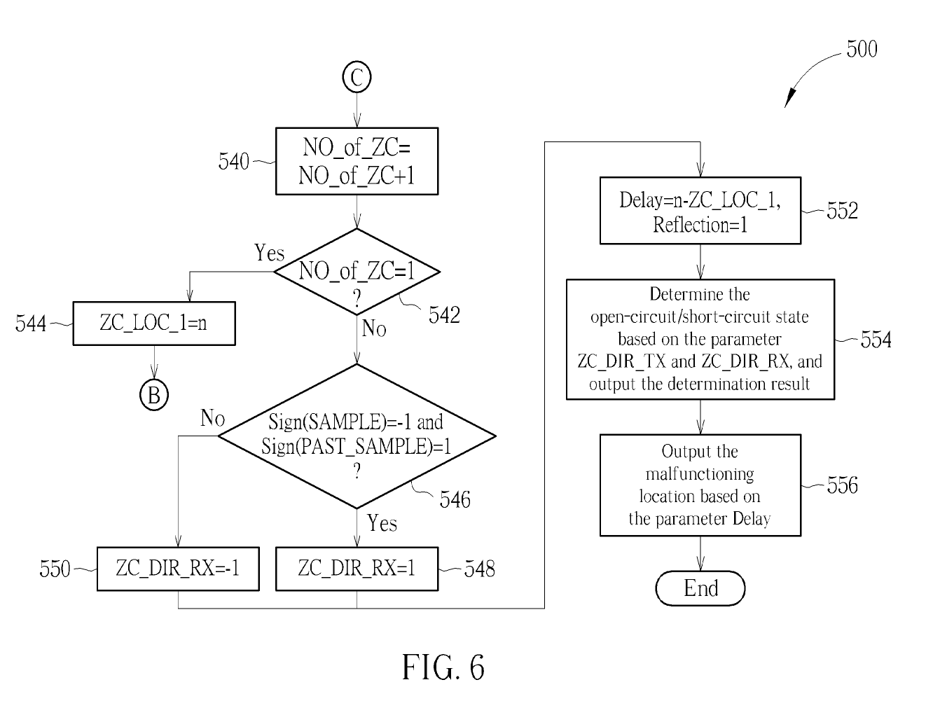

FIG. 5 is a diagram illustrating a portion of a work flow 500 according to an embodiment of the present invention, and FIG. 6 is a diagram illustrating another portion of the work flow 500 shown in FIG. 5.

In Step 510, the hybrid diagnostics circuit 110HYB may set the waveform type of the zero-crossing wave to be transmitted. For example, the zero-crossing wave may be implemented as the zero-crossing signal ZCTX, such as one of the zero-crossing signals ZCTX+ and ZCTX−.

In Step 512, the hybrid diagnostics circuit 110HYB may determine whether the waveform changes to negative from positive when the zero-crossing wave passes through the zero level. For example, the zero-crossing wave may be configured to have the zero-crossing direction of the zero-crossing signal ZCTX− (e.g. downwards), and thus be determined as changing to negative from positive. In another example, the zero-crossing wave may be implemented to have the zero-crossing direction of the zero-crossing signal ZCTX+ (e.g. upwards), and thus the waveform is determined as changing to positive from negative. When the waveform changes to negative from positive, the work flow goes to Step 514; otherwise, the flow goes to Step 516.

In Step 514, the hybrid diagnostics circuit 110HYB may set the parameter ZC_DIR_TX as 1 (i.e. ZC_DIR_TX=1).

In Step 516, the hybrid diagnostics circuit 110HYB may set the parameter ZC_DIR_TX as −1 (ZC_DIR_TX=−1).

In Step 518, the hybrid diagnostics circuit 110HYB may control the transmitter TX to transmit the zero-crossing wave.

In Step 520, the hybrid diagnostics circuit 110HYB may set some parameters as follows:
n=0;
NO_of_ZC=0;
ZC_LOC_1=0; and
PAST_SAMPLE=0;
   wherein the symbol “n” represents the index. For better understanding, the symbol “SAMPLE” represents a temporary sample value, such as the current sample value of the analog-to-digital converter ADC. Further, the symbol “PAST_SAMPLE” represents another temporary sample value, such as a previous sample value of the analog-to-digital converter ADC.

In Step 522, the hybrid diagnostics circuit 110HYB may receive the current sample value SAMPLE, and will increase the value of the index n (e.g. n=n+1).

In Step 524, the hybrid diagnostics circuit 110HYB may check whether “Sign(SAMPLE)≠Sign(PAST_SAMPLE)” is true or false, wherein the symbol “Sign( )” may represent a positive or negative sign. For example, when “Sign(SAMPLE)≠Sign(PAST_SAMPLE)” is true (i.e. the sign of the current sample value SAMPLE is opposite to the sign of the previous sample value PAST_SAMPLE), the work flow goes to Step 526; otherwise, the work flow goes to Step 530.

In Step 526, the hybrid diagnostics circuit 110HYB may calculate the parameter ZC_AMP_RX as follows: ZC_AMP_RX=|SAMPLE−PAST_SAMPLE|; wherein the symbol “| |” represents an absolute value.

In Step 528, the hybrid diagnostics circuit 110HYB may check whether “ZC_AMP_RX>ZC_AMP_THR” is true. If “ZC_AMP_RX>ZC_AMP_THR” is true, the work flow goes to Step 540 (through the node C); otherwise, the work flow goes to Step 530 (through the node B).

In Step 530, the hybrid diagnostics circuit 110HYB may replace the previous sample value PAST_SAMPLE with the current sample value SAMPLE. This operation may be expressed as follows: PAST_SAMPLE=SAMPLE.

In Step 532, the hybrid diagnostics circuit 110HYB may check whether “n<=N” is true, wherein the symbol “N” represents a predetermined value. For example, when “n<=N” is true (i.e. the index n is smaller than or equal to the predetermined value N), the work flow goes to Step 522; otherwise, the work flow goes to Step 534.

In Step 534, the hybrid diagnostics circuit 110HYB may set the parameter Reflection as 0 (i.e. Reflection=0), to indicate that there is no reflection wave.

In Step 540, the hybrid diagnostics circuit 110HYB may increase the value of the parameter NO_of_ZC, wherein the increased amount each time is 1 (i.e. NO_of_ZC=NO_of_ZC+1).

In Step 542, the hybrid diagnostics circuit 110HYB may check whether “NO_of_ZC=1” is true. If “NO_of_ZC=1” is true, the work flow goes to Step 544; otherwise, the work flow goes to Step 546.

In Step 544, the hybrid diagnostics circuit 110HYB may set the parameter ZC_LOC_1 as n (i.e. ZC_LOC_1=n). Then, the work flow goes to Step 530 (through the node B).

In Step 546, the hybrid diagnostics circuit 110HYB may check whether both “Sign(SAMPLE)=−1” and “Sign(PAST_SAMPLE)=1” are true. If both “Sign(SAMPLE)=−1” and “Sign(PAST_SAMPLE)=1” are true (i.e. the current sample value SAMPLE is negative, and the previous sample value PAST_SAMPLE is positive), the work flow goes to Step 548; otherwise, the work flow goes to Step 550.

In Step 548, the hybrid diagnostics circuit 110HYB may set the parameter ZC_DIR_RX as 1 (i.e. ZC_DIR_RX=1), to indicate that the zero-crossing direction of the reflection wave (e.g. the reflection signal ZCRX) of the zero-crossing wave changes to negative from positive.

In Step 550, the hybrid diagnostics circuit 110HYB may set the parameter ZC_DIR_RX as −1 (e.g. ZC_DIR_RX=−1), to indicate that the zero-crossing direction of the reflection wave (e.g. the reflection signal ZCRX) of the zero-crossing wave changes to positive from negative.

In Step 552, the hybrid diagnostics circuit 110HYB may set the parameter Delay as (n−ZC_LOC_1) (i.e., Delay=(n−ZC_LOC_1)), and set the parameter Reflection as 1 (i.e. Reflection=1) to indicate that there is a reflection wave.

In Step 554, based on the parameter ZC_DIR_TX and ZC_DIR_RX, the hybrid diagnostics circuit 110HYB may determine the open-circuit/short-circuit state, and accordingly output the determination result. For example, the hybrid diagnostics circuit 110HYB may refer to one of the situations shown in FIG. 3, to find and output a corresponding determination result (e.g. one of the open-circuit and short-circuit determination results).

In Step 556, based on the parameter Delay, the hybrid diagnostics circuit 110HYB may output the malfunctioning location of the cable. For example, the sample period of the analog-to-digital converter ADC may be a known parameter, and the parameter Delay corresponds to the time difference between the reflection wave and the zero-crossing wave. More particularly, according to the sample period and parameter Delay of the analog-to-digital converter ADC, the hybrid diagnostics circuit 110HYB may calculate the time difference between the reflection wave and the zero-crossing wave. Since the speed of an electronic wave is a known parameter, the hybrid diagnostics circuit 110HYB may refer to the time difference to calculate the malfunctioning location of the cable.

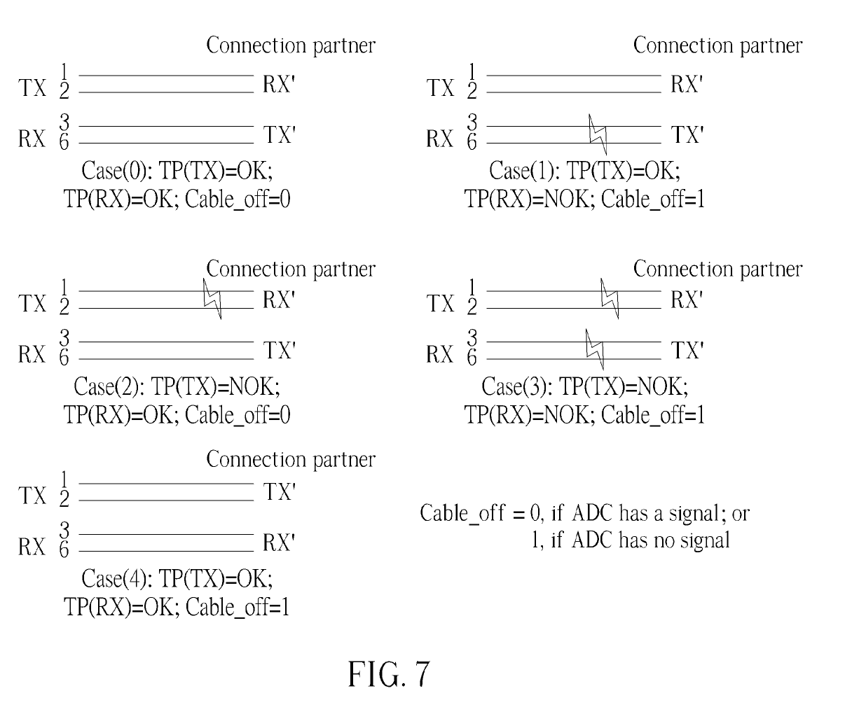

FIG. 7 is a diagram illustrating various types of situations according to an embodiment of the present invention. In this embodiment, a connection partner of the electronic device 100, such as the other electronic device, may comprise the transmitter TX′ and the receiver RX′. The two ends of the cable may be connected to the electronic device 100 and the other electronic device, respectively. A connector of the electronic device 100 may be connected to the cable, wherein the connector comprises a plurality of terminals, such as the terminals {1, 2, 3, 4, 5, 6, 7, 8}. The terminals {1, 2} of the connector may be a set of data output terminals, and the terminals {3, 6} of the connector may be a set of data input terminals. The hybrid diagnostics circuit 110HYB may control the conduction paths in the switching circuit 120, to make the terminals {1, 2} of the connector be electrically connected to the transmitter TX, and make the terminals {3, 6} of the connector be electrically connected to the receiver RX, for transceiving data.

For better understanding, one twisted pair within the twisted pairs {TP (1), TP (2), TP (3), TP (4)} connected to the transmitter TX through the terminals {1, 2} may be called the twisted pair TP(TX), and the twisted pair connected to the receiver RX through terminals {3, 6} may be called the twisted pair TP(RX). In some cases, the two wires of the twisted pair TP(TX) are connected to the terminals {1, 2}, and the two wires of the twisted pair TP(RX) are connected to the terminals {3, 6}. The aforementioned cases may comprise Case (0), Case (1), Case (2), Case (3) and Case (4), which are illustrated as follows:
Case (0): The twisted pair TP(TX) does not malfunction (denoted as “TP (TX)=OK” in FIG. 7), and the twisted pair TP (RX) does not malfunction (denoted as “TP (RX)=OK” in FIG. 7), wherein the hybrid diagnostics circuit 110HYB may refer to the state “the parameter Cable_off outputted by the detection signal comparator circuit 130 is set to 0” to determine that the receiver RX can receive signals;
Case (1): The twisted pair TP(TX) does not malfunction (denoted as “TP(TX)=OK” in FIG. 7), and the twisted pair TP(RX) malfunctions (denoted as “TP(RX)=NOK” in FIG. 7), wherein the hybrid diagnostics circuit 110HYB may refer to the state “the parameter Cable_off outputted by the detection signal comparator circuit 130 is set to 1” to determine that the receiver RX cannot receive any signal;
Case (2): The twisted pair TP(TX) malfunctions (denoted as “TP(TX)=NOK” in FIG. 7), and the twisted pair TP(RX) does not malfunction (denoted as “TP(RX)=OK” in FIG. 7), wherein the hybrid diagnostics circuit 110HYB may refer to the state “the parameter Cable_off outputted by the detection signal comparator circuit 130 is set to 0” to determine that the receiver RX can receive signals;
Case (3): The twisted pair TP(TX) malfunctions (denoted as “TP(TX)=NOK” in FIG. 7), and the twisted pair TP(RX) malfunctions (denoted as “TP(RX)=NOK” in FIG. 7), wherein the hybrid diagnostics circuit 110HYB may refer to the state “the parameter Cable_off outputted by the detection signal comparator circuit 130 is set to 1” to determine that the receiver RX cannot receive any signal; and
Case (4): The twisted pair TP(TX) does not malfunction (denoted as “TP (TX)=OK” in FIG. 7), and the twisted pair TP (RX) does not malfunction (denoted as “TP (RX)=OK” in FIG. 7), wherein the hybrid diagnostics circuit 110HYB may refer to the state the parameter Cable_off outputted by the detection signal comparator circuit 130 is set to 1, to determine that the receiver RX cannot receive any signal.

Note that each of the lightening shape symbols show in FIG. 7 represents a malfunction of a twisted pair, but this is merely for illustrative purposes, and is not a limitation of the present invention.

In this embodiment, the zero-crossing signal ZCTX and the reflection signal ZCRX are differential signals. Further, the hybrid diagnostics circuit 110HYB may refer to a plurality of sample values (e.g. a sample value {SAMPLE} corresponding to a different time point) of the analog-to-digital converter ADC to determine whether the receiver RX receives any signal. During a predetermined monitoring period where the transmitter TX transmits the zero-crossing signal ZCTX to the target twisted pair TP, the hybrid diagnostics circuit 110HYB may check whether all the sample values (e.g. the sample value {SAMPLE}) of the analog-to-digital converter ADC are substantially zero, wherein the hybrid diagnostics circuit 110HYB may refer to a predetermined threshold value to filter noise. For example, the hybrid diagnostics circuit 110HYB may forcedly set any of the sample values whose absolute value is lower than the predetermined threshold value to zero, or directly take this kind of sample value as zero (i.e. ignore this sample value), in order to determine whether the receiver RX receives any signal during the predetermined monitoring period. In this way, by forcedly resetting the sample value corresponding to noise to zero, or viewing this sample value as zero, the hybrid diagnostics circuit 110HYB may prevent the influence of the noise.

According to some embodiments, the hybrid diagnostics circuit 110HYB may perform a series of hybrid diagnostics operations. The series of hybrid diagnostics operations may be presented as follows:

Close auto MDI/MDIX, close Autoneg, switch to MDI TX[1,2], RX[3,6]
Maycrossover = 0;

| | |
|---|---|
| If RX[3 6] Cable_off==0 | //[3 6] not disconnected |

| | |
|---|---|
| TX[1 2]←→RX[3 6]; | //exchange TX, RX => TX[3 6], RX[1,2] |

| | |
|---|---|
| if RX[1 2] Cable_off==0 | //check whether [1 2] is |
| | disconnected or not |
| report cable no fault; | //report that both [1 2] and [3 6] |
| | are OK |
| else | //[1 2] is possibly disconnected |
| RX[1 2]←→TX[3 6]; | //exchange TX, RX again => TX[1 2], |
| | RX[3 6] |
| issue pulse; | //issue a pulse on TX[1 2] |
| if (reflection) | //there is a reflection |

```
      report [1 2] fault pattern and loc.; //[1 2] disconnected
    else
```

| | |
|---|---|
| report cable no fault; | //[1 2] and [3 6] are not |
| | disconnected, but the connection |
| | partner is fixed at TX[3 6] and RX[1 |
| | 2] => no jumping function |
| else | //RX[3 6] is possibly disconnected |
| TX[1 2]←→RX[3 6]; | //exchange TX, RX => RX[1 2], TX[3 |
| | 6] |
| issue pulse; | //issue a pulse on TX[3 6] |
| if (reflection) | //detect whether there is a |
| | reflection |

report [3 6] fault pattern and loc.; //there is a

| | |
|---|---|
| | reflection => [3 6] is disconnected |
| else | |
| maycrossover = 1; | // there is no reflection, and the |
| | connection partner is fixed at TX[1 |
| | 2] and RX[3 6] => crossover |
| if RX[1 2] Cable_off==0 | //determine whether [1 2]is |
| | disconnected |
| report [1 2] no fault; | //[1 2] is not disconnected |
| if (maycrossover==1) | //[1 2] is not disconnected, and [3 |
| | 6] is also not disconnected |

report cable no fault but crossover; // the connection

| | |
|---|---|
| | partner is fixed at TX[1 2] and RX[3 |
| | 6] => crossover |
| else | //[1 2] is disconnected |
| if (maycrossover==1) | |
| report [3 6] no fault; | //[3 6] is not disconnected |
| TX[3 6]←→RX[1 2]; | //exchange TX, RX => TX[1 2], RX[3 |
| | 6] |
| issue pulse; | //issue a pulse on [1 2] |
| if (reflection) | //there is a reflection => TX[1 2] |
| | is disconnected |

report [1 2] fault pattern and loc.; //TX[1 2] is

disconnected

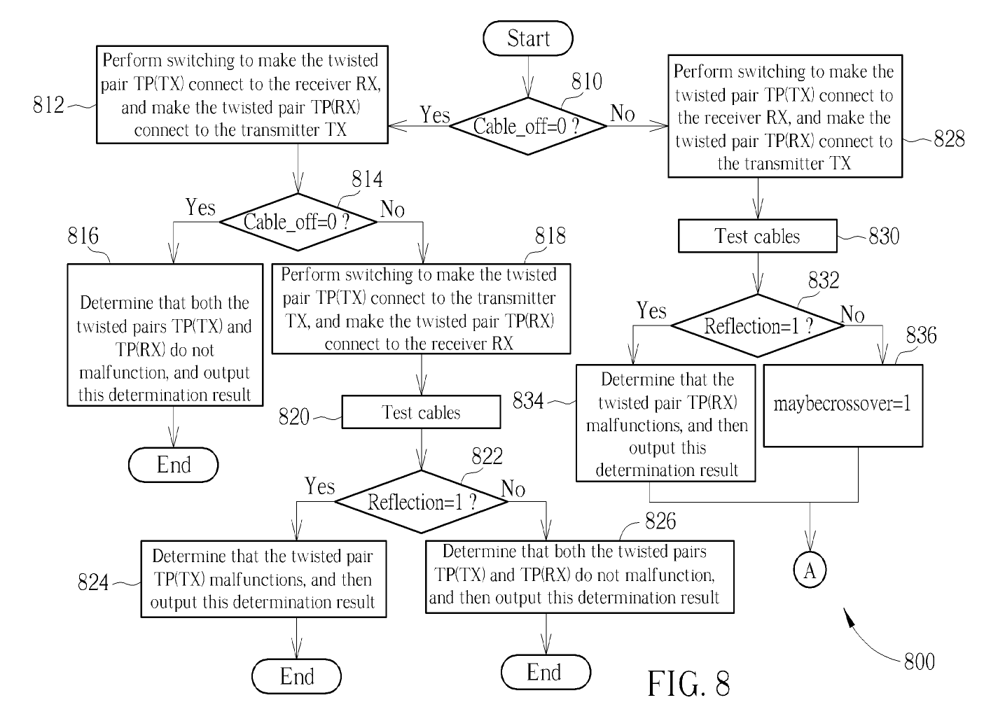

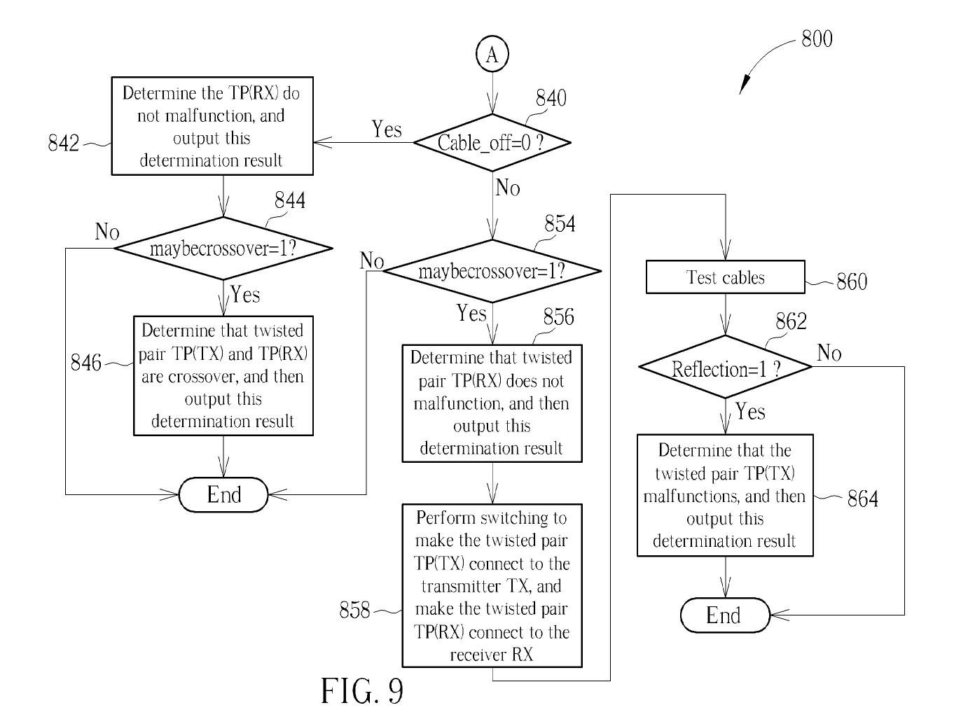

FIG. 8 is a diagram illustrating a portion of a work flow 800 according to another embodiment of the present invention. FIG. 9 is a diagram illustrating another portion of the work flow 800 shown in FIG. 8. The work flow 800 may correspond to the series of hybrid diagnostics operations. Note that in the work flow 800, regarding any step for checking whether the parameter Cable_off equals 0, the hybrid diagnostics circuit 110HYB may obtains the latest value of the parameter Cable_off based on the operations of the embodiment shown in FIG. 7, in order to determine whether the parameter Cable_off is equal to 0.

In Step 810, the hybrid diagnostics circuit 110HYB may check whether “Cable_off=0” is true. If “Cable_off=0” is true (i.e. the parameter Cable_off is equal to 0), the work flow goes to 812; otherwise, the work flow goes to 828.

In Step 812, the hybrid diagnostics circuit 110HYB may control the switching circuit 120 to perform a switching operation, to make the twisted pair TP(TX) connect to the receiver RX, and make the twisted pair TP(RX) connect to the transmitter TX.

In Step 814, the hybrid diagnostics circuit 110HYB may check whether “Cable_off=0” is true. When “Cable_off=0” is true (i.e. the parameter Cable_off is equal to 0), the work flow goes to 816; otherwise, the work flow goes to 818.

In Step 816, the hybrid diagnostics circuit 110HYB may determine that both the twisted pairs TP(TX) and TP(RX) do not malfunction, and output this determination result.

In Step 818, the hybrid diagnostics circuit 110HYB may control the switching circuit 120 to perform a switching operation, to make the twisted pair TP(TX) connect to the transmitter TX, and make the twisted pair TP(RX) connect to the receiver RX.

In Step 820, the hybrid diagnostics circuit 110HYB may perform tests on cables. For example, the hybrid diagnostics circuit 110HYB may refer to the work flow 500 to perform tests on cables, wherein the twisted pair TP(RX) currently connected to the receiver RX is used as the target twisted pair TP.

In Step 822, the hybrid diagnostics circuit 110HYB may check whether “Reflection=1” is true. If “Reflection=1” is true (i.e. the parameter Reflection is equal to 1), the work flow goes to 824; otherwise, the work flow goes to 826.

In Step 824, the hybrid diagnostics circuit 110HYB may determine that the twisted pair TP(TX) malfunctions, and then output this determination result.

In Step 826, the hybrid diagnostics circuit 110HYB may determine that both the twisted pairs TP(TX) and TP(RX) do not malfunction, and then output this determination result.

In Step 828, the hybrid diagnostics circuit 110HYB may control the switching circuit 120 to perform switching, to make the twisted pair TP(TX) connect to the receiver RX, and make the twisted pair TP(RX) connect to the transmitter TX.

In Step 830, the hybrid diagnostics circuit 110HYB may perform tests on cables. For example, the hybrid diagnostics circuit 110HYB may refer to the work flow 500 to perform tests on cables, wherein the twisted pair TP(TX) currently connected to the receiver RX is used as the target twisted pair TP.

In Step 832, the hybrid diagnostics circuit 110HYB may check whether “Reflection=1” is true. When “Reflection=1” is true (i.e. the parameter Reflection is equal to 1), the work flow goes to 834; otherwise, the work flow goes to 836.

In Step 834, the hybrid diagnostics circuit 110HYB may determine that the twisted pair TP(RX) malfunctions, and then output this determination result. After the determination result is outputted, the work flow goes to 840 (through the node A).

In Step 836, the hybrid diagnostics circuit 110HYB may set the parameter maybecrossover to 1. After that, the work flow goes to 840 (through the node A).

In Step 840, the hybrid diagnostics circuit 110HYB may check whether “Cable_off=0” is true. If “Cable_off=0” is true (i.e. the parameter Cable_off is equal to 0), the work flow goes to 842; otherwise, the work flow goes to 854.

In Step 842, the hybrid diagnostics circuit 110HYB may determine that the twisted pair TP(TX) malfunctions, and then output this determination result.

In Step 844, the hybrid diagnostics circuit 110HYB may check whether “maybecrossover=1” is true. If “maybecrossover=1” is true (i.e. the parameter maybecrossover is equal to 1), the work flow goes to 846; otherwise, the work flow 800 ends.

In Step 846, the hybrid diagnostics circuit 110HYB may determine that twisted pair TP (TX) and TP (RX) are crossover, and then output this determination result.

In Step 854, the hybrid diagnostics circuit 110HYB may check whether “maybecrossover=1” is true. If “maybecrossover=1” is true (i.e. the parameter maybecrossover is equal to 1), the work flow goes to 856; otherwise, the work flow 800 ends.

In Step 856, the hybrid diagnostics circuit 110HYB may determine that twisted pair TP (RX) does not malfunction, and then output this determination result.

In Step 858, the hybrid diagnostics circuit 110HYB may control the switching circuit 120 perform switching, to make the twisted pair TP(TX) connect to the transmitter TX, and make the twisted pair TP(RX) connect to the receiver RX.

In Step 860, the hybrid diagnostics circuit 110HYB may perform tests on cables. For example, the hybrid diagnostics circuit 110HYB may refer to the work flow 500 to perform tests on cables, wherein the twisted pair TP(RX) currently connected to the receiver RX is used as the target twisted pair TP.

In Step 862, the hybrid diagnostics circuit 110HYB may check whether “Reflection=1” is true. If “Reflection=1” is true (i.e. the parameter Reflection is equal to 1), the work flow goes to 864; otherwise, the work flow 800 ends.

In Step 864, the hybrid diagnostics circuit 110HYB may determine that the twisted pair TP(TX) malfunctions, and then output this determination result.

In some embodiments, the detection signal comparator circuit 130, rather than the hybrid diagnostics circuit 110HYB, may refer to the output signal of the receiver RX to perform at least one comparing operation (e.g. one or more comparing operations), in order to generate the parameter Cable_off, wherein in response to the comparing result of the comparing operation, the logic value of the parameter Cable_off maybe 0 or 1. For example, the detection signal comparator circuit 130 may comprise at least one comparator arranged to perform the aforementioned at least one comparing operation. In another example, the detection signal comparator circuit 130 may comprise at least one logic gate which is arranged to generate the logic value 0 or 1 of the parameter Cable_off according to the comparing result.

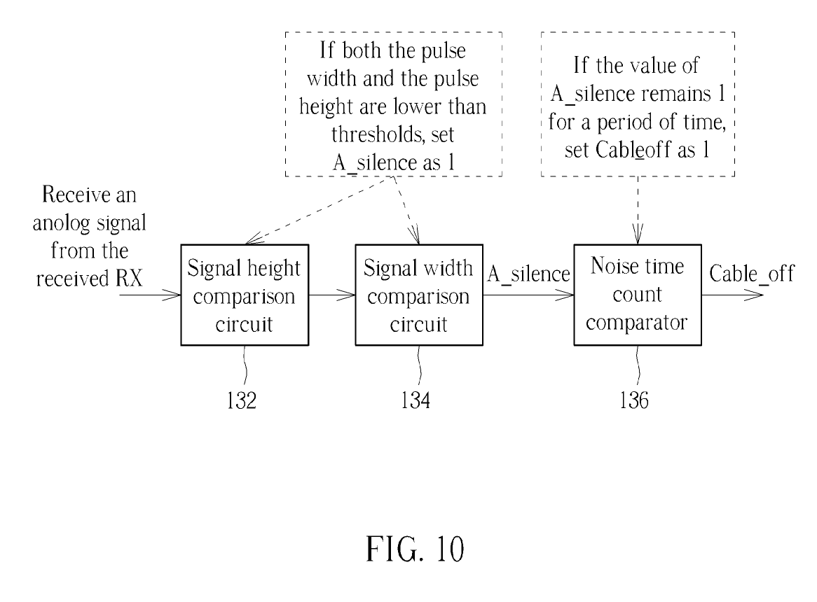

FIG. 10 is a diagram illustrating implementation details of the detection signal comparing circuit 130 shown in FIG. 1 according to an embodiment of the present invention. Note that the output signal of the receiver RX is an analog signal. In this embodiment, the detection signal comparator circuit 130 may comprise a signal height comparison circuit 132, a signal width comparison circuit 134 and a noise time count comparator 136. The signal height comparison circuit 132 and the signal width comparison circuit 134 may receive the analog signal from the receiver RX, and perform a height comparing operation and a width comparing operation upon the analog signal. The noise time count comparator 136 may perform a time comparing operation upon a period of time where the logic value of the parameter A_silence remains at a predetermined logic value (e.g. the logic value 1). For example, during the height comparing operation, the signal height comparison circuit 132 may compare the height of a pulse in the analog signal with a height threshold value, in order to generate a height comparing result. Further, during the comparing operation, the signal width comparison circuit 134 may compare the width of the pulse with a width threshold value, in order to generate a width comparing result. Based on the height comparing result and the width comparing result, when the height of the pulse is smaller than the height threshold value and the width of the pulse is smaller than the width threshold value (which suggests that the pulse may be noise), the detection signal comparator circuit 130 will set the logic value of the parameter A_silence as the predetermined logic value, such as the logic value 1; otherwise, the detection signal comparator circuit 130 will set the logic value of the parameter A_silence as another predetermined logic value, such as the logic value 0. For example, the detection signal comparator circuit 130 may comprise one or more logic gates (not shown in FIG. 10), in order to refer to the height comparing result and the width comparing result to generate the logic value of the parameter Cable_off 0 or 1. Further, during the time comparing operation, the noise time count comparator 136 may compare the time period (i.e. the time period where the logic value of the parameter A_silence remains at the predetermined logic value) with a time threshold value, in order to generate a time comparing result. Based on the time comparing result, when the time period is larger than or equal to the time threshold value, the detection signal comparator circuit 130 (especially the noise time count comparator 136) may set the logic value of the parameter Cable_off as 1; otherwise, the detection signal comparator circuit 130 (especially the noise time count comparator 136) may set the logic value of the parameter Cable_off as 0. This is merely for illustrative purposes, and is not a limitation of the present invention. According to some embodiments, the time comparison result may represent that the logic value of the parameter Cable_off is 0 or 1.

As shown in the embodiment of FIG. 1, the detection signal comparator circuit 130 is positioned external to the processing circuit 110, but this is merely for illustrative purposes, and is not a limitation of the present invention. In some embodiments, the detection signal comparator circuit 130 may be integrated into the processing circuit 110.

According to some embodiments, the processing circuit 110 (e.g. the hybrid diagnostics circuit 110HYB) may perform hybrid diagnostics operations through time domain reflection characteristics, such as the series of hybrid diagnostics operations. The processing circuit 110 (e.g. the hybrid diagnostics circuit 110HYB) may check whether the receiver RX receives any signal from the other electronic device through one of the twisted pairs {TP (1), TP (2), TP (3), TP (4)} (e.g. the target twisted pair TP, such as twisted pair TP(RX) or twisted pair TP(TX)). In addition, according to whether the receiver RX receives any signal from the other electronic device through the twisted pair, the processing circuit 110 (e.g. the hybrid diagnostics circuit 110HYB) may perform at least one follow-up operation (e.g. one or more follow-up operations) to determine whether the cable malfunctions. At least one portion of the follow-up operation may be related to the target twisted pair TP. For example, the portion of the follow-up operation may comprise a cable testing process, wherein the cable testing process may comprise: utilizing the transmitter TX to transmit the zero-crossing signal ZCTX to the target twisted pair TP, utilizing the receiver RX to receive the reflection signal ZCRX of the zero-crossing signal ZCTX from the target twisted pair TP, and detecting the characteristic of the reflection signal ZCRX in order to generate the determination result to allow the electronic device 100 to process according to the determination result. Examples of the cable testing process may comprise (but are not limited to): at least one portion of the steps mentioned in the work flow 500, e.g. the cable testing performed in Steps 820, 830, and 860.

According to some embodiments, the twisted pair (e.g. the twisted pair TP(RX)) is connected to a data input terminal (e.g. terminals {3, 6}) in the connector, and another twisted pair (e.g. the twisted pair TP(TX)) of the twisted pairs is connected to a data output terminal (e.g. terminals {1, 2}) in the connector. Further, the follow-up operation may comprise: utilizing the switching circuit 120 to perform path switching, in order to temporarily switch between a set of inner paths corresponding to the other twisted pair and a set of inner paths corresponding to the twisted pair; and checking whether the receiver RX receives any signal from the other electronic device through the other twisted pair. For example, the follow-up operation may further comprise: after temporarily switching between the set of inner paths corresponding to the other twisted pair (e.g. the twisted pair TP(TX)) and the set of inner paths corresponding to the twisted pair (e.g. the twisted pair TP(RX)), if the receiver RX receives any signal from the other electronic device through the other twisted pair, determining that both the twisted pair and the other twisted pair normally operate; otherwise, utilizing the switching circuit 120 to perform path switching, in order to cancel the switching between the set of inner paths corresponding to the other twisted pair and the set of inner paths corresponding to the twisted pair, to make the twisted pair be selected as the target twisted pair TP. For example, the follow-up operation may further comprise: performing the cable testing process after the switching between the set of inner paths corresponding to the other twisted pair and the set of inner paths corresponding to the twisted pair is canceled for making the twisted pair be selected as the target twisted pair TP.

According to some embodiments, the twisted pair (e.g. the twisted pair TP (RX)) is connected to the data input terminal (e.g. terminals {3, 6}) in the connector, and another twisted pair (e.g. the twisted pair TP (TX)) within the twisted pairs is connected to the data output terminal (e.g. terminals {1, 2}) of the connector. Further, the follow-up operation may comprise: utilize the switching circuit 120 to perform path switching to temporarily switch between a set of inner paths corresponding to another twisted pair of the twisted pairs and a set of inner paths corresponding to the twisted pair, to make the other twisted pair be temporarily selected as the target twisted pair TP; and perform the cable testing process after the switching between the set of inner paths corresponding to the other twisted pair and the set of inner paths corresponding to the twisted pair is executed in order to make the other twisted pair be temporarily selected as the target twisted pair TP. The follow-up operation may further comprise: checking whether the receiver RX receives any signal from the other electronic device through the other twisted pair. The follow-up operation may further comprise: at least according to whether the receiver RX receives any signal from the other electronic device through the other twisted pair, determine whether the twisted pair (e.g. the twisted pair TP(RX)) and the other twisted pair (e.g. the twisted pair TP (TX)) are crossed over.

According to some embodiments, the follow-up operation may further comprise: when it is determined that the twisted pair (e.g. the twisted pair TP (RX)) and the other twisted pair (e.g. the twisted pair TP(TX)) are crossed over, reserving the switching between the set of inner paths corresponding to the other twisted pair and the set of inner paths corresponding to the twisted pair, in order to perform data transceiving. In this way, through utilizing the switching circuit 120, the processing circuit 110 (e.g. the hybrid diagnostics circuit 110HYB) may prevent the crossover, in order to allow the electronic device 100 to transceive data.

The method and apparatus of the present invention may properly solve existing problems without introducing side effects, or in a way that is less likely to introduce side effects. Further, the method and apparatus of the present invention may automatically detect wrong wirings during hybrid diagnostics, and more particularly, may automatically fix the wrong wirings through switching paths. Hence, the method and apparatus of the present invention may effectively raise the overall efficiency of the network system.

Those skilled in the art will readily observe that numerous modifications and alterations of the device and method may be made while retaining the teachings of the invention. Accordingly, the above disclosure should be construed as limited only by the metes and bounds of the appended claims.

1. A method for performing cable diagnostics in a network system, the network system comprising a cable, the method comprising:
utilizing a transmitter to transmit a zero-crossing signal to a target twisted pair in the cable, wherein the transmitter is positioned in an electronic device of the network system, and an end of the cable is electrically connected to the electronic device, and the zero-crossing signal has a zero-crossing waveform, wherein the zero-crossing waveform comprises a zero-crossing direction indicating a direction of passing through a zero level;
utilizing a receiver to receive a reflection signal of the zero-crossing signal from the target twisted pair, wherein the receiver is positioned in the electronic device;
detecting at least one characteristic of the reflection signal; and generating at least one determination result by comparing the zero-crossing signal and the at least one characteristic of the reflection signal, in order to allow the electronic device to process according to the determination result.

2. The method of claim 1, wherein the reflection signal has a zero-crossing waveform, and the characteristic of the reflection signal comprises a zero-crossing direction of the zero-crossing waveform of the reflection signal.

3. The method of claim 2, wherein when the zero-crossing direction of the zero-crossing waveform of the reflection signal is the same as the zero-crossing direction of the zero-crossing waveform of the zero-crossing signal, the determination result comprises an open-circuit determination result, wherein the open-circuit determination result indicates that two wires of the target twisted pair are open-circuit with respect to each other.

4. The method of claim 2, wherein when the zero-crossing direction of the zero-crossing waveform of the reflection signal is opposite to the zero-crossing direction of the zero-crossing waveform of the zero-crossing signal, the determination result comprises a short-circuit determination result, wherein the short-circuit determination result indicates that two wires of the target twisted pair are short-circuited.

5. The method of claim 1, further comprising:
utilizing a switching circuit to perform path switching, in order to allow the transmitter to transmit the zero-crossing signal to the target twisted pair, and allow the receiver to receive the reflection signal from the target twisted pair, wherein the switching circuit is positioned in the electronic device.

6. The method of claim 1, further comprising:
checking whether the receiver receives any signal from another electronic device of the network system through a twisted pair within a plurality of twisted pairs of the cable; and
according to whether the receiver receives any signal from the other electronic device through the twisted pair, performing at least one follow-up operation to determine whether the cable malfunctions.

7. The method of claim 6, wherein at least one portion of the follow-up operation is related to the target twisted pair, and the target twisted pair is selected from the twisted pairs.

8. The method of claim 7, wherein the portion of the follow-up operation comprises a cable testing process, wherein the cable testing process comprises:
utilizing the transmitter to transmit the zero-crossing signal to the target twisted pair in the cable;
utilizing the receiver to receive the reflection signal of the zero-crossing signal from the target twisted pair; and
detecting the characteristic of the reflection signal to generate the determination result, in order to allow the electronic device to process according to the determination result.

9. The method of claim 6, wherein at least one portion of the follow-up operation comprises a cable testing process, wherein the cable testing process comprises:
utilizing the transmitter to transmit the zero-crossing signal to the target twisted pair in the cable;
utilizing the receiver to receive the reflection signal of the zero-crossing signal from the target twisted pair; and
detecting the characteristic of the reflection signal to generate the determination result, in order to allow the electronic device to process according to the determination result.

10. The method of claim 1, wherein the zero-crossing signal and the reflection signal are both differential signals.

11. An apparatus for performing cable diagnostics in a network system, the network system comprising a cable, and the apparatus comprising:
a transmitter, positioned in an electronic device of the network system, the transmitter arranged to transmit a zero-crossing signal to a target twisted pair in the cable, wherein an end of the cable is electrically connected to the electronic device, and the zero-crossing signal has a zero-crossing waveform, wherein the zero-crossing waveform comprises a zero-crossing direction indicating a direction of passing through a zero level;
a receiver, positioned in the electronic device, the receiver arranged to receive a reflection signal of the zero-crossing signal from the target twisted pair; and
a processing circuit, positioned in the electronic device, the processing circuit coupled to the transmitter and the receiver, and arranged to detect at least one characteristic of the reflection signal to generate at least one determination result by comparing the zero-crossing signal and the at least one characteristic of the reflection signal, in order to allow the electronic device to process according to the determination result.

12. The apparatus of claim 11, wherein the reflection signal has a zero-crossing waveform, and the characteristic of the reflection signal comprises a zero-crossing direction of the zero-crossing waveform of the reflection signal.

13. The apparatus of claim 12, wherein when the zero-crossing direction of the zero-crossing waveform of the reflection signal is the same as the zero-crossing direction of the zero-crossing waveform of the zero-crossing signal, the determination result comprises an open-circuit determination result, wherein the open-circuit determination result indicates that two wires of the target twisted pair are open-circuit with respect to each other.

14. The apparatus of claim 12, wherein when the zero-crossing direction of the zero-crossing waveform of the reflection signal is opposite to the zero-crossing direction of the zero-crossing waveform of the zero-crossing signal, the determination result comprises a short-circuit determination result, wherein the short-circuit determination result indicates that two wires in the target twisted pair are short-circuited.

15. The apparatus of claim 11, further comprising:
a switching circuit, positioned in the electronic device, the switching circuit arranged to perform path switching, in order to allow the transmitter to transmit the zero-crossing signal to the target twisted pair, and allow the receiver to receive the reflection signal from the target twisted pair.

16. The apparatus of claim 11, wherein the processing circuit checks whether the receiver receives any signal from another electronic device in the network system through a twisted pair within a plurality of twisted pairs of the cable; and according to whether the receiver receives any signal from the other electronic device through the twisted pair, the processing circuit performs at least one follow-up operation to determine whether the cable malfunctions.

17. The apparatus of claim 16, wherein at least one portion of the follow-up operation is related to the target twisted pair, and the target twisted pair is selected from the twisted pairs.

18. The apparatus of claim 17, wherein the portion of the follow-up operation comprises a cable testing process, wherein the cable testing process comprises:
utilizing the transmitter to transmit the zero-crossing signal to the target twisted pair in the cable;
utilizing the receiver to receive the reflection signal of the zero-crossing signal from the target twisted pair; and
detecting the characteristic of the reflection signal to generate the determination result, in order to allow the electronic device to process according to the determination result.

19. The apparatus of claim 16, wherein at least one portion of the follow-up operation comprises a cable testing process that comprises:
utilizing the transmitter to transmit the zero-crossing signal to the target twisted pair in the cable;
utilizing the receiver to receive the reflection signal of the zero-crossing signal from the target twisted pair; and
detecting the characteristic of the reflection signal to generate the determination result, in order to allow the electronic device to process according to the determination result.

20. The apparatus of claim 11, wherein the zero-crossing signal and the reflection signal are both differential signals.
